(19) United States
(12) Patent Application Publication
(10) Pub. No.: US 2008/0174813 A1
(43) Pub. Date: Jul. 24, 2008

(54) DATA TRANSMISSION APPARATUS, IMAGE FORMING APPARATUS AND METHODS THEREOF

(75) Inventors: Hyung-jae YOO, Suwon-si (KR); Hoe-go Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/972,804

(22) Filed: Jan. 11, 2008

(30) Foreign Application Priority Data
Jan. 23, 2007 (KR) 2007-7006

(51) Int. Cl. G06F 3/12

(52) U.S. Cl. 358/1.15

(57) ABSTRACT

A data transmission apparatus includes a user interface part to set a reference domain in data displayed on a screen; a data generator to convert the data into print data if a print command for the data is input, and to generate transmission data by adding reference domain information regarding the set reference domain to the converted print data; and an interface part to transmit the generated transmission data to an image forming apparatus. Therefore, a user can more conveniently print the reference documents contained in a document, such as a thesis or a publication, by only setting the reference domain, without separate operations.

### CROSS-REFERENCE TO RELATED APPLICATIONS

This application claims priority under 35 U.S.C. § 119 (a) of Korean Patent Application No. 10-2007-0007006, filed on Jan. 23, 2007, in the Korean Intellectual Property Office, the disclosure of which is incorporated herein by reference in its entirety.

### BACKGROUND OF THE INVENTION

1. Field of the Invention

The present general inventive concept relates to a data transmission apparatus, an image forming apparatus, and methods thereof. More particularly, the present general inventive concept relates to a data transmission apparatus, an image forming apparatus, and methods thereof, which enable reference documents to be downloaded and printed using transmission data including reference domain information.

2. Description of the Related Art

Generally, image forming apparatuses are connected to data transmission apparatuses, such as personal computers (PCs), in order to print data transmitted from the data transmission apparatuses onto print material, such as paper. Specifically, if a user browses documents such as theses or technical reports, using webpages or application programs (for example, word processors) on a PC, the user may also require additional documents referred to in the browsed documents. Such references to additional documents include server information, such as Unified Resource Identifiers (URIs), so that a user can access the server through the Internet to download reference documents according to activation of the Internet. Specifically, the user may access the server on which the reference documents are stored using the server information, and then may download the corresponding reference documents. Additionally, if the user desires to print the downloaded reference document, the user can search for and print the downloaded reference documents.

As described above, several operations, such as accessing the server, downloading, searching for reference documents, printing, or other operations, are required to be performed in order to print the documents referred to in the documents by the user, thus causing user inconvenience. In particular, this problem may be maximized in the situation in which a single document refers to many other documents which a user desires to print. Therefore, a need exists for a method of more easily printing documents referred to in the document.

### SUMMARY OF THE INVENTION

The present general inventive concept provides a data transmission apparatus, an image forming apparatus, and methods thereof, which enable reference documents to be downloaded and printed using transmission data including reference domain information so that the reference documents can be printed more easily.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a data transmission apparatus including a user interface part to set a reference domain in data displayed on a screen; a data generator to convert the data into print data if a print command for the data is input, and to generate transmission data by adding reference domain information regarding the set reference domain to the converted print data; and an interface part to transmit the generated transmission data to an image forming apparatus.

The user interface part may include a display part to display data on the screen; an input part to designate a certain domain in the data displayed on the screen; and a user interface (UI) processor to generate a user interface window including a reference domain setting menu to set the designated domain as a reference domain if the certain domain is designated, and to display the window by the display part. The data generator may recognize the designated domain as the reference domain, if the reference domain setting menu is selected.

The reference domain information may include Unified Resource Identifier (URI) information.

The data generator may prepare text contained in the reference domain in Extensible Hypertext Markup Language (XHTML) format to generate the reference domain information.

The foregoing and/or other aspects and utilities of the present general inventive concept may be achieved by providing an image forming apparatus including an interface part to receive transmission data including reference domain information; and a controller to access a server using server information contained in the reference domain information and download a reference document corresponding to the reference domain information, if the reference domain information is detected in the received transmission data.

The image forming apparatus may further include a display part, and if the reference domain information is detected, the controller may control the display part to display the reference domain information on a screen.

The image forming apparatus may further include an input part, and if a print command for the displayed reference domain information is input through the input part, the controller may access the server to download the reference document corresponding to the reference domain information.

The image forming apparatus may further include a printing part, and if the print command for the displayed reference domain information is input and the reference document is downloaded from the server, the controller may control the printing part to print the downloaded reference document.

The image forming apparatus may further include a display part, and if a user authentication request is received, the controller may control the display part to display a message to receive information required for user authentication.

The controller may access the server using Unified Resource Identifier (URI) information contained in the reference domain information.

The foregoing and/or other aspects and utilities of the present general inventive concept may also be achieved by providing a data transmission method of a data transmission apparatus, including setting a reference domain in data displayed on a screen; receiving a print command for the data; converting the data into print data and generating transmission data by adding reference domain information regarding the set reference domain to the converted print data; and transmitting the generated transmission data to an image forming apparatus.

The setting may include displaying data on the screen; designating a certain domain in the data displayed on the screen; generating a user interface window including a reference domain setting menu to set the designated domain as a reference domain if the certain domain is designated, and displaying the window; and setting the designated domain as the reference domain, if the reference domain setting menu is selected on the user interface window.

The reference domain information may include Unified Resource Identifier (URI) information.

The converting may include preparing text contained in the reference domain in Extensible Hypertext Markup Language (XHTML) format to generate the reference domain information.

The foregoing and/or other aspects and utilities of the present general inventive concept may be achieved by providing an image forming method of an image forming apparatus, including receiving transmission data including reference domain information; accessing the server using the reference domain information contained in the received transmission data; downloading a reference document corresponding to the reference domain information from the server; and printing the downloaded reference document.

The accessing may include displaying the reference domain information on the screen; receiving a print command for the displayed reference domain information; and accessing the server using server information contained in the reference domain information if the print command is input.

The image forming method may further include receiving a user authentication request from the server; and displaying a message to receive information required for user authentication.

The server information may be Unified Resource Identifier (URI) information contained in the reference domain information.

The foregoing and/or other aspects and utilities of the present general inventive concept may also be achieved by providing a data communication system, comprising: an data transmission device to set a reference domain in data displayed on a screen, to convert the data into print data if a print command for the data is input, and to generate transmission data by adding reference domain information regarding the set reference domain to the converted print data, and to transmit the generated transmission data to the image forming apparatus; and image forming apparatus to receive transmission data including the reference domain information from the data transmission device, and to access a server using server information contained in the reference domain information and download a reference document corresponding to the reference domain information, if the reference domain information is detected in the received transmission data.

The foregoing and/or other aspects and utilities of the present general inventive concept may also be achieved by providing a data communication method comprising: setting a reference domain in data displayed on a screen; receiving a print command for the data; converting the data into print data and generating transmission data by adding reference domain information regarding the set reference domain to the converted print data; transmitting the transmission data including reference domain information to an image forming apparatus; accessing a server using the reference domain information contained in the received transmission data at the image forming apparatus; downloading a reference document corresponding to the reference domain information from the server; and printing the downloaded reference document at the image forming apparatus.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is an exemplary view illustrating the operating environment of an image forming system according to an exemplary embodiment of the present general inventive concept;

FIG. 2 is a block diagram illustrating a detailed construction of an image forming system according to an exemplary embodiment of the present general inventive concept;

FIG. 3 is an exemplary block diagram illustrating a detailed construction of a data transmission apparatus applicable to the image forming system of FIG. 1;

FIG. 4 is an exemplary block diagram illustrating a detailed construction of an image forming apparatus applicable to the image forming system of FIG. 1;

FIG. 5 is an exemplary view illustrating a reference domain setting screen according to an exemplary embodiment of the present general inventive concept;

FIG. 6 is an exemplary view illustrating a reference domain information display screen according to an exemplary embodiment of the present general inventive concept;

FIG. 7 is a flowchart explaining a data transmission method according to an exemplary embodiment of the present general inventive concept;

FIG. 8 is a flowchart explaining an image forming method according to an exemplary embodiment of the present general inventive concept; and

FIG. 9 is a flowchart explaining an image forming method according to another exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

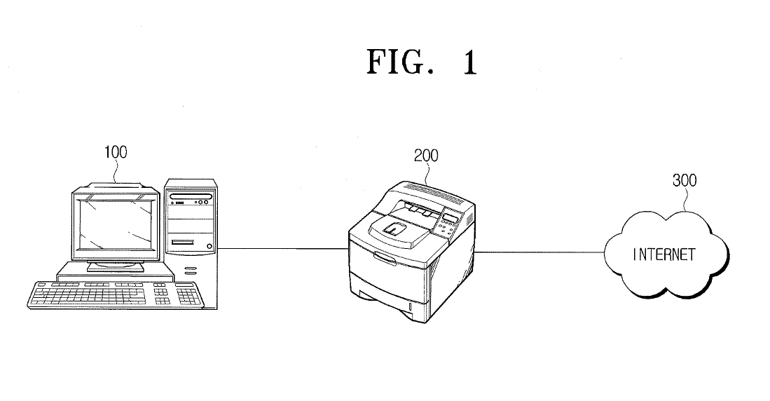

FIG. 1 is an exemplary view illustrating the operating environment of an image forming system according to an exemplary embodiment of the present general inventive concept. In FIG. 1, the operating environment of the image forming system comprises a data transmission apparatus 100, an image forming apparatus 200, and an Internet 300.

If a certain domain including a reference document is designated in data while the data, such as a document, is being displayed on a screen using a webpage or an application program (for example, a word processor), the data transmission apparatus 100 can set the designated domain as a reference domain.

If a print command for the data is input after the reference domain is set, the data transmission apparatus 100 can convert the data into print data, and generate transmission data obtained by adding reference domain information regarding the set reference domain to the converted print data. In this situation, the reference domain information refers to information relating to a reference document corresponding to a portion set as a reference domain, and may include Unified Resource Identifier (URI) information, that is, server information including reference details (title, date of publication, author) and the reference document. Additionally, the reference domain information can be generated in Extensible Hypertext Markup Language (XHTML) format. Subsequently, the data transmission apparatus 100 can transmit the transmission data to the image forming apparatus 200 in response to the print command.

If the transmission data is received from the data transmission apparatus 100, the image forming apparatus 200 can detect the reference domain information contained in the transmission data. The image forming apparatus 200 can access a server using the detected reference domain information and download a reference document corresponding to the reference domain information. Specifically, if the detected reference domain information is displayed on the screen and a user then inputs a print command for the reference domain information, the image forming apparatus 200 may access the server and download the reference document corresponding to the reference domain information. The image forming apparatus 200 can access the server via the Internet 300 which is connected to the image forming apparatus 200.

If the reference document corresponding to the reference domain information is downloaded by accessing the server through the Internet 300, the image forming apparatus 200 can print the downloaded reference document. When printing the reference document, the print data contained in the transmission data can also be printed along with the reference document. Accordingly, the user can set the reference document contained in the document as a reference domain, and thus it is possible to print the reference document more easily.

Although the operating environment of FIG. 1 was described using a personal computer (PC) as the data transmission apparatus 100, any device such as a mobile phone, a plasma display panel (PDP) or the like capable of displaying a webpage using the Internet can be applied. Additionally, as illustrated in FIG. 1, the image forming apparatus 200 is illustrated as being connected to the data transmission apparatus 100 via a local interface, but may alternatively be connected via a network interface.

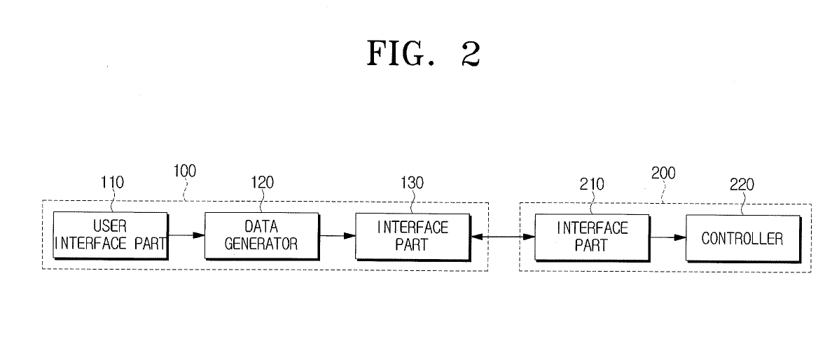

FIG. 2 is a block diagram illustrating a detailed construction of an image forming system according to an exemplary embodiment of the present general inventive concept. In FIG. 2, the data transmission apparatus 100 includes a user interface part 110, a data generator 120, and an interface part 130.

The user interface part 110 can set the reference domain according to a user. Specifically, reference domain setting is performed in order to set the reference document recorded on the data displayed on the screen as a reference domain. The user can designate the reference document of a certain domain, and then input a reference domain setting command. Accordingly, the user interface part 110 can set the designated domain as a reference domain. In addition, the user interface part 110 can receive the print command for the data.

The data generator 120 can generate transmission data in response to the print command. Specifically, if a print command for the data displayed on the screen is input, the data generator 120 can convert the data into print data, and generate transmission data by adding to the converted print data the reference domain information on the reference domain. In this situation, the reference domain information refers to information relating to the reference document corresponding to a portion set as a reference domain, and may include URI information including the reference details (title, date of publication, author) and the reference document. Additionally, the data generator 120 can prepare text contained in the reference domain in Extensible Hypertext Markup Language (XHTML) format to generate the reference domain information.

The transmission data generated by the data generator 120 may include Printer Job Language (PJL) which is used for print commands, in addition to the print data and reference domain information.

The interface part 130 is connected to the image forming apparatus 200 in order to receive data from and transmit data to the image forming apparatus 200. Specifically, the interface part 130 can transmit the transmission data generated by the data generator 120 to the image forming apparatus 200.

The image forming apparatus 200 includes an interface part 210 and a controller 220.

The interface part 210 is connected to the data transmission apparatus 100 in order to receive data from and transmit data to the data transmission apparatus 100. Specifically, the interface part 210 can receive the transmission data including the reference domain information through the data transmission apparatus 100.

The controller 220 can detect the reference domain information from the received transmission data, and then access a server (not shown) using server information contained in the reference domain information to download the reference document corresponding to the reference domain information. Accordingly, a user can more easily download the reference document without a need to directly access the server.

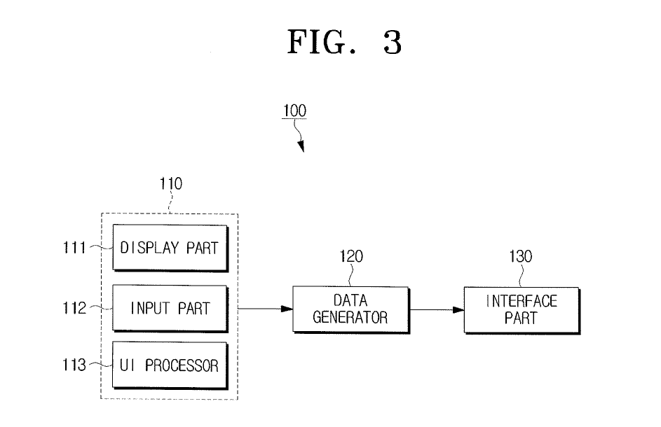

FIG. 3 is an exemplary block diagram illustrating a detailed construction of a data transmission apparatus applicable to the image forming system of FIG. 1. As illustrated in FIG. 3, the data transmission apparatus 100 includes the user interface part 110, the data generator 120, and the interface part 130.

The user interface part 110 includes a display part 111, an input part 112, and a user interface (UI) processor 113.

The display part 111 can display data on the screen. In this situation, the data may be a document, such as a thesis or a publication, which is displayed using a webpage or an application program (for example, a word processor).

The input part 112 can designate a certain domain in the data displayed on the screen. Specifically, the input part 112 can be implemented as, for example, a mouse, a keyboard, or other input device. A user can designate the domain by directly marking the domain on the screen through the input part 112.

If the certain domain is designated on the data through the input part 112, the UI processor 113 can generate a user interface window comprising a reference domain setting menu to set the designated domain as a reference domain, and can display the window. Accordingly, the user can select the reference domain setting menu using the input part 112, and thus it is possible to set the designated domain as a reference domain.

In other words, if the reference domain setting menu is selected through the user interface window displayed by the UI processor 113, the data generator 120 can recognize the designated domain to be a reference domain. Therefore, if a print command for the data displayed on the screen is input through the input part 112, the data generator 120 can convert the data into print data, and generate transmission data obtained by adding to the converted print data the reference domain information on the domain recognized as the reference domain. At this time, the transmission data can be ordered so as to start with the PJL used for print commands, followed by the reference domain information, and finally the print data. Accordingly, the transmission data can be generated in a manner in which the reference domain information is contained between the PJL and print data.

The interface part 130 can transmit the transmission data generated by the data generator 120 to the image forming apparatus 200.

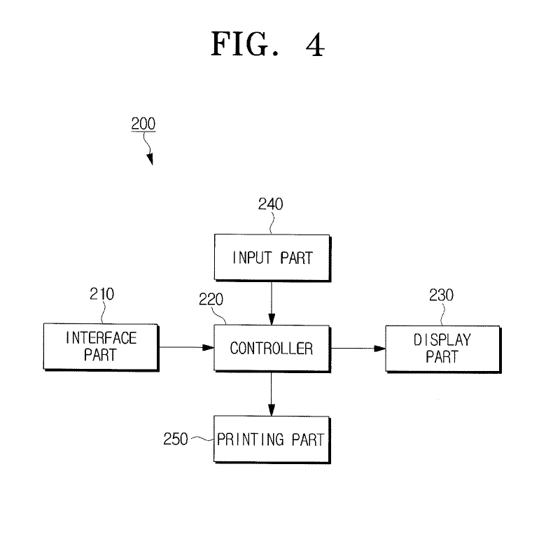

FIG. 4 is an exemplary block diagram illustrating a detailed construction of an image forming apparatus applicable to the image forming system of FIG. 1. In FIG. 4, the image forming apparatus 200 includes the interface part 210, the controller 220, a display part 230, an input part 240, and a printing part 250.

The interface part 210 can receive the transmission data from the data transmission apparatus 100.

The display part 230 can display the reference domain information on the screen. Specifically, the display part 230 can display the reference details (title, date of publication, author) from the reference domain information on the screen. Additionally, the display part 230 can display a predetermined message on the screen. The display part 230 may be a Liquid Crystal Display (LCD) panel included in a main body of the image forming apparatus 200.

The input part 240 can receive a print command for the reference domain information.

The printing part 250 can print the print data and the reference domain corresponding to the reference domain information.

The controller 220 can control the entire operation of the image forming apparatus 200. Specifically, if the transmission data is received through the interface part 210, the controller 220 can detect the reference domain information from the transmission data. If the reference domain information is detected, the controller 220 can control the display part 230 to display the reference domain information on the screen. The transmission data can be ordered so as to start with the PJL used for print commands, followed by the reference domain information, and finally the print data. Accordingly, data between the end point of the PJL and the start point of the print data can be determined to be reference domain information. Alternatively, data between the point informing that PJL is reference domain information and the start point of the print data can be determined to be reference domain information.

If the print command for the reference domain information is input while the reference domain information is being displayed, the controller 220 can access a corresponding server using the URI information, that is, server information contained in the reference domain information. Accordingly, the reference document corresponding to the reference domain information can be downloaded.

When the controller 220 accesses the server using the URI information, a user authentication request may be received from the corresponding server. At this time, the controller 220 can control the display part 230 to display a message to receive information required for user authentication. Accordingly, the user can input the information required for user authentication, for example, an ID and password, through the message, and can access the server.

The controller 220 can control the printing part 250 to print the downloaded reference document and the print data. The print data and reference document need not be printed at the same time, and the print data can be printed at a time when the transmission data is received through the interface part 210.

When the transmission data is received through the interface part 210, if the reference domain information is not detected from the transmission data, the controller 220 can control the printing part 250 to directly print the print data contained in the transmission data.

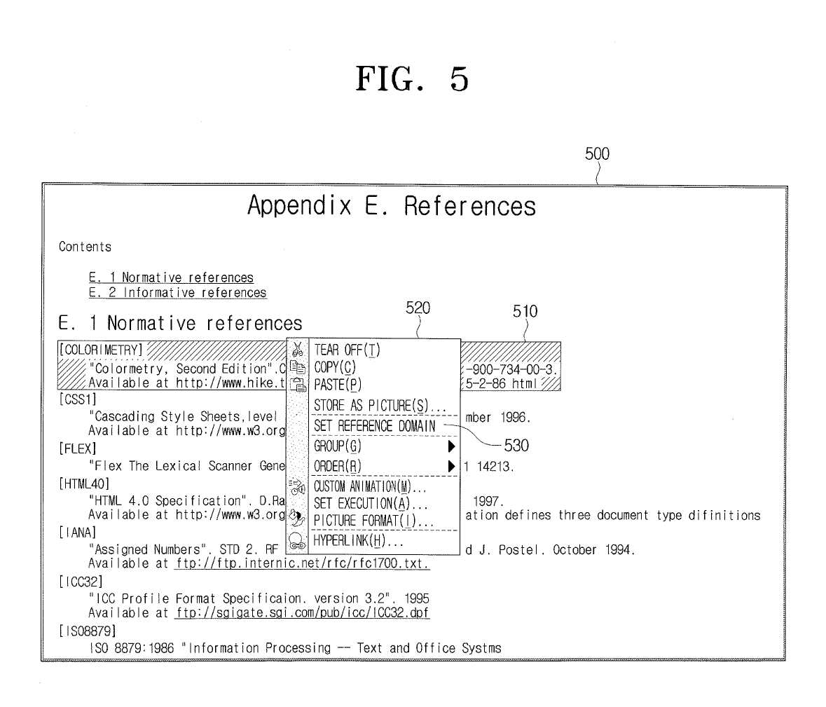

FIG. 5 is an exemplary view illustrating a reference domain setting screen according to an exemplary embodiment of the present general inventive concept. In FIG. 5, a predetermined data set 500 is displayed on a screen of the data transmission apparatus 100, and the reference documents are arranged in a form of a list in the data set 500.

The user can mark a reference document which the user desires to print from among the reference documents contained in the data set 500 using an input means, such as a mouse. In this situation, marking can be performed for each reference document, and a single reference document can be entirely marked. In other words, all the reference details (title, date of publication, author) and URI information can be marked.

Next, if the user clicks the right button of the mouse while a single domain 510 is marked, a user interface window 520 can be displayed. The user interface window 520 may include a reference domain setting menu 530 to set the domain marked by the user as a reference domain.

If the user selects the reference domain setting menu 530 from the user interface window 520, the domain 510 marked by the user can be set as a reference domain. In other words, the data transmission apparatus 100 can recognize the corresponding domain to be a reference domain. In this manner, several reference documents can be set as a reference domain.

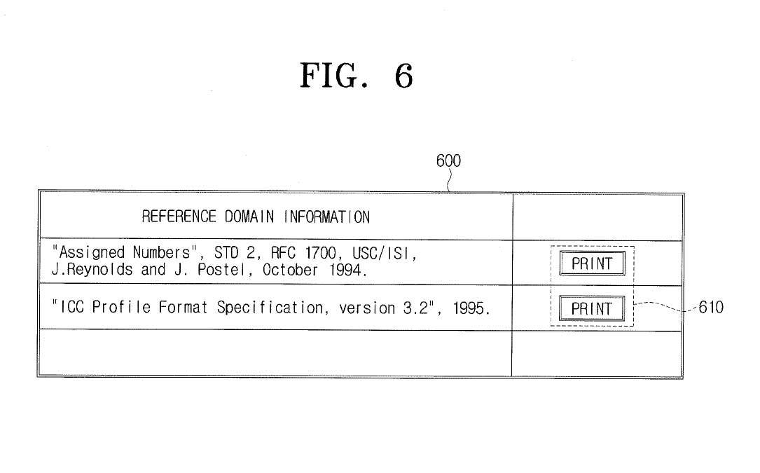

FIG. 6 is an exemplary view illustrating a reference domain information display screen according to an exemplary embodiment of the present general inventive concept. In FIG. 6, a reference domain information table 600 can be displayed on the LCD panel of the image forming apparatus 200. Specifically, the reference domain information table 600 can be obtained by detecting the reference domain information from the transmission data received through the data transmission apparatus 100 and displaying the detected information. The reference domain information displayed on the LCD panel may include the reference details (title, date of publication, author), and thus the user can understand the reference domain information more easily.

In the reference domain information table 600 of FIG. 6, information on two reference domains can be displayed at the top and the bottom thereof, and the table 600 includes an input domain 610 at the right side of each reference domain information in order to input the print commands. If the user desires to print a reference document corresponding to “‘Assigned Numbers’, STD 2, RFC 1700, USC/IS, J. Reynolds and J. Postel, October 1994” which is the reference domain information at the top of the table 600, the user can press the input domain at the right side of the reference domain information. Accordingly, the image forming apparatus 200 can access the server using the URI information contained in the reference domain information at the top, and then print the matching reference document by downloading. Therefore, the reference documents can be more easily printed by only setting the reference domain, without the need to perform operations such as accessing the server, downloading, searching for reference documents, printing, or other operations in order to print the reference documents contained in the data.

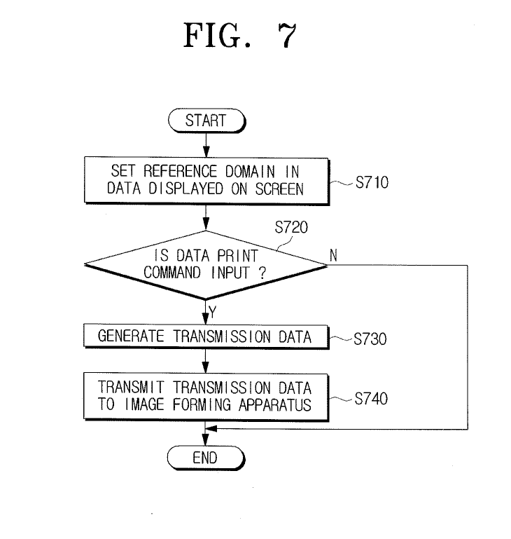

FIG. 7 is a flowchart illustrating a data transmission method according to an exemplary embodiment of the present general inventive concept. In FIG. 7, the data transmission apparatus 100 can set the reference domain in the data being displayed on the screen in operation S710. Specifically, if a user marks a certain domain in the data displayed on the screen, the data transmission apparatus 100 can designate the domain marked by the user. Next, if the certain domain is designated in the data, the reference domain setting menu contained in the user interface window can be selected, and the designated domain can be set as a reference domain.

If a print command for the data is input while the reference domain is being set in operation S720, the data transmission apparatus 100 can generate transmission data in operation S730. In other words, if the data print command is input while the reference domain is being set, the data transmission apparatus 100 can convert the data into print data to generate transmission data obtained by adding to the converted print data the reference domain information on the reference domain. The transmission data may further include PJL used for print commands, in addition to the print data and reference domain information.

The data transmission apparatus 100 can transmit the generated transmission data to the image forming apparatus 200 in operation S740. Accordingly, the reference domain information set by the user can be contained in the print data to be transmitted to the image forming apparatus 200.

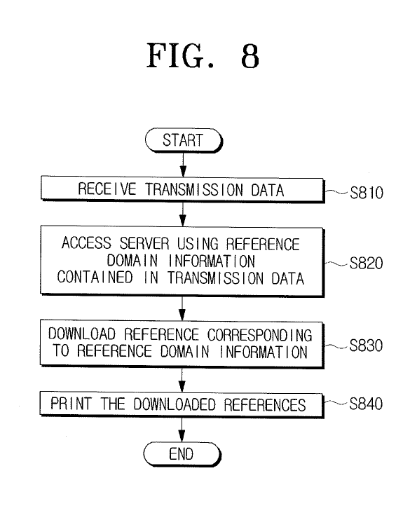

FIG. 8 is a flowchart illustrating an image forming method according to an exemplary embodiment of the present general inventive concept. In FIG. 8, the image forming apparatus 200 can receive the transmission data from the data transmission apparatus 100 in operation S810. The transmission data may include only the print data, or can further include the reference domain information in addition to the print data. The reference domain information refers to information relating to the reference document corresponding to a portion set as a reference domain, and may include the URI information, that is, server information in which the reference details (title, date of publication, author) and the reference documents are being stored.

The image forming apparatus 200 can access the server using the reference domain information contained in the transmission data in operation S820. Server accessing can be performed using the URI information contained in the reference domain information.

The image forming apparatus 200 can download the reference document corresponding to the reference domain information from the server in operation S830, and print the downloaded reference document in operation S840. According to this manner described above, it is possible to download and print the reference documents using the reference domain information more conveniently.

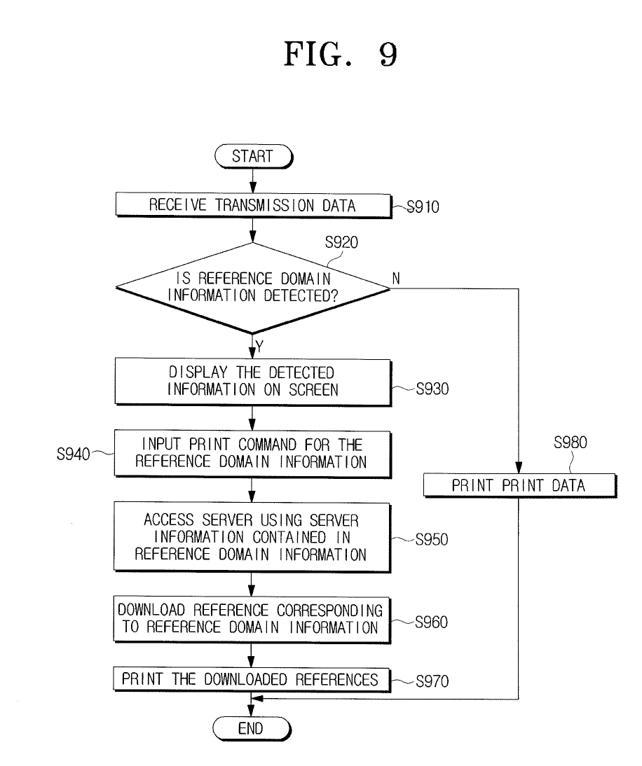

FIG. 9 is a flowchart illustrating an image forming method according to another exemplary embodiment of the present general inventive concept. As illustrated in FIG. 9, the image forming apparatus 200 can receive the transmission data from the data transmission apparatus 100 in operation S910.

If the reference domain information is detected in the received transmission data in operation S920, the image forming apparatus 200 can display the detected reference domain information on the screen in operation S930. Specifically, the image forming apparatus 200 can display the reference details (title, date of publication, author) in the reference domain information on the screen.

If the print command for the displayed reference domain information is input in operation S940, the image forming apparatus 200 can access the server using the server information contained in the reference domain information in operation S950. If a user authentication request is received from the server in order to access the server, the image forming apparatus 200 can display a message to receive information required for user authentication. Accordingly, the user can input the information required for user authentication to the message to access the server.

The image forming apparatus 200 can download the reference document from the server in operation S960, and print the downloaded reference document in operation S970. When printing the reference document, the print data contained in the transmission data can also be printed along with the reference document.

If the reference domain information is not detected in the received transmission data in operation S920, the image forming apparatus 200 can print the print data in operation S980. Accordingly, the user can print the reference document corresponding to the reference domain information more conveniently, using only the print command for the reference domain information without separate operations.

As described above, the present general inventive concept provides that the reference documents can be more easily printed by only setting the reference domain, without the need to perform operations such as accessing the server, downloading, searching for reference documents, printing, or other operations in order to print the reference documents contained in the documents, such as a thesis or a publication, which increases user convenience.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A data transmission apparatus connected to an image forming apparatus, comprising:
a user interface part to set a reference domain in data displayed on a screen;
a data generator to convert the data into print data if a print command for the data is input, and to generate transmission data by adding reference domain information regarding the set reference domain to the converted print data; and
an interface part to transmit the generated transmission data to the image forming apparatus.

2. The data transmission apparatus as claimed in claim 1, wherein the user interface part comprises:
a display part to display data on the screen;
an input part to designate a certain domain in the data displayed on the screen; and
a user interface (UI) processor to generate a user interface window including a reference domain setting menu to set the designated domain as a reference domain if the certain domain is designated, and to display the window by the display part,
wherein the data generator recognizes the designated domain as the reference domain, if the reference domain setting menu is selected.

3. The data transmission apparatus as claimed in claim 1, wherein the reference domain information comprises Unified Resource Identifier (URI) information.

4. The data transmission apparatus as claimed in claim 1, wherein the data generator prepares text contained in the reference domain in Extensible Hypertext Markup Language (XHTML) format to generate the reference domain information.

5. An image forming apparatus comprising:
a display part;
an input part;
an interface part to receive transmission data including reference domain information; and
a controller to access a server using server information contained in the reference domain information and download a reference document corresponding to the reference domain information, if the reference domain information is detected in the received transmission data,
wherein, if the reference domain information is detected, the controller controls the display part to display the reference domain information on a screen, and if a print command for the displayed reference domain information is input through the input part, the controller accesses the server to download the reference document corresponding to the reference domain information.

6. The image forming apparatus as claimed in claim 5, further comprising a printing part,
wherein, if the print command for the displayed reference domain information is input and the reference document is downloaded from the server, the controller controls the printing part to print the downloaded reference document.

7. The image forming apparatus as claimed in claim 5, wherein, if a user authentication request is received, the controller controls the display part to display a message to receive information required for user authentication.

8. The image forming apparatus as claimed in claim 5, wherein the controller accesses the server using Unified Resource Identifier (URI) information contained in the reference domain information.

9. A data transmission method of a data transmission apparatus, comprising:
setting a reference domain in data displayed on a screen;
receiving a print command for the data;
converting the data into print data and generating transmission data by adding reference domain information regarding the set reference domain to the converted print data; and
transmitting the generated transmission data to an image forming apparatus.

10. The data transmission method as claimed in claim 9, wherein the setting comprises:
displaying data on the screen;
designating a certain domain in the data displayed on the screen;
generating a user interface window including a reference domain setting menu to set the designated domain as a reference domain if the certain domain is designated, and displaying the window; and
setting the designated domain as the reference domain, if the reference domain setting menu is selected on the user interface window.

11. The data transmission method as claimed in claim 9, wherein the reference domain information comprises Unified Resource Identifier (URI) information.

12. The data transmission method as claimed in claim 9, wherein the converting comprises preparing text contained in the reference domain in Extensible Hypertext Markup Language (XHTML) format to generate the reference domain information.

13. An image forming method of an image forming apparatus, comprising:
receiving transmission data including reference domain information;
accessing the server using the reference domain information contained in the received transmission data;
downloading a reference document corresponding to the reference domain information from the server; and
printing the downloaded reference document,
wherein the accessing comprises:
displaying the reference domain information on the screen;
receiving a print command for the displayed reference domain information; and
accessing the server using server information contained in the reference domain information if the print command is input.

14. The image forming method as claimed in claim 13, further comprising:
receiving a user authentication request from the server; and
displaying a message to receive information required for user authentication.

15. The image forming method as claimed in claim 13, wherein the server information is Unified Resource Identifier (URI) information contained in the reference domain information.

16. A data communication system, comprising:
a data transmission device to set a reference domain in data displayed on a screen, to convert the data into print data if a print command for the data is input, and to generate transmission data by adding reference domain information regarding the set reference domain to the converted print data, and to transmit the generated transmission data to the image forming apparatus; and
an image forming apparatus to receive transmission data including the reference domain information from the data transmission device, and to access a server using server information contained in the reference domain information and download a reference document corresponding to the reference domain information, if the reference domain information is detected in the received transmission data.

17. The data communication system as claimed in claim 16, wherein the data transmission device comprises:
a user interface part to set the reference domain in the data displayed on a screen;
a data generator to convert the data into print data if a print command for the data is input, and to generate the transmission data by adding the reference domain information regarding the set reference domain to the converted print data; and
an interface part to transmit the generated transmission data to the image forming apparatus.

18. The data communication system as claimed in claim 16, wherein the image forming apparatus comprises:
an interface part to receive the transmission data including reference domain information; and
a controller to access the server using the server information contained in the reference domain information and to download a reference document corresponding to the reference domain information, if the reference domain information is detected in the received transmission data.

19. A data communication method comprising:
setting a reference domain in data displayed on a screen;
receiving a print command for the data;
converting the data into print data and generating transmission data by adding reference domain information regarding the set reference domain to the converted print data;
transmitting the transmission data including reference domain information to an image forming apparatus;
accessing a server using the reference domain information contained in the received transmission data at the image forming apparatus;
downloading a reference document corresponding to the reference domain information from the server; and
printing the downloaded reference document at the image forming apparatus.
